(19) United States
(12) Patent Application Publication
(10) Pub. No.: US 2023/0010516 A1
(43) Pub. Date: Jan. 12, 2023

(54) INPUT/OUTPUT (I/O) QUIESCING FOR SEQUENTIAL ORDERING OF OPERATIONS IN A WRITE-AHEAD-LOG (WAL)-BASED STORAGE SYSTEM

(71) Applicant: VMware, Inc., Palo Alto, CA (US)

(72) Inventors: Enning XIANG, San Jose, CA (US); Wenguang WANG, Santa Clara, CA (US); Nitin RASTOGI, San Bruno, CA (US); Pranay SINGH, San Ramon, CA (US); Subhradyuti SARKAR, Newark, CA (US)

(21) Appl. No.: 17/368,254

(22) Filed: Jul. 6, 2021

(51) Int. Cl. G06F 3/06

(52) U.S. Cl. CPC G06F 3/0656; G06F 3/061; G06F 3/0679

(57) ABSTRACT

A method for of input/output (I/O) quiescing in a write-ahead-log (WAL)-based storage system comprising a WAL, is provided. The method generally includes receiving a request to process a control operation for the storage system, determining whether a memory buffer includes payload data for one or more write requests previously received for the storage system and added to the WAL, forcing a flush of the payload data in the memory buffer to a persistent layer of the storage system when the memory buffer includes the payload data, and processing the control operation subsequent to completing the asynchronous flush, without waiting for processing of one or more other write requests in the WAL corresponding to payload data that was not added to the memory buffer prior to receiving the request to process the control operation.

### BACKGROUND

Distributed storage systems allow multiple clients in a network to access a pool of shared resources. For example, a distributed storage system allows a cluster of host computers to aggregate local disks (e.g., solid state drive (SSD), peripheral component interconnect (PCI)-based flash storage, etc.) located in, or attached to, each host computer to create a single and shared pool of storage. This pool of storage (sometimes referred to herein as a “datastore” or “data storage”) is accessible by all host computers in the host cluster and may be presented as a single namespace of storage entities, such as a hierarchical file system namespace in the case of files, a flat namespace of unique identifiers in the case of objects, etc. Data storage clients in turn, such as virtual machines (VMs) spawned on the host computers, may use the datastore, for example, to store virtual disks.

A host computer may perform a variety of data processing tasks and operations using the distributed object-based datastore. In particular, each host computer may include a storage management module used to perform basic system input/output (I/O) operations in connection with data requests, such as data read and write operations by accessing disks of VMs stored within the datastore. For example, an I/O request to write a block of data may be received by a storage management module, and through a distributed object manager (DOM) sub-module of the storage management module, the data may be stored in a physical memory (e.g., a bank) and a data log, the data log being stored over a number of physical blocks in the datatstore.

A distributed object-based datastore, such as a virtual storage area network (VSAN) datastore, may provide write optimized architecture by using a write-ahead-log (WAL), copy-on-write (COW) techniques, and erasure coding (EC) full stripe writes. In particular, WALs provide atomicity and durability guarantees in datastores by persisting every change as a command to an append-only log before they are written to the datastore. COW techniques improve performance and provide time and space efficient snapshot creation by only copying metadata about where the original data is stored, as opposed to creating a physical copy of the data, when a snapshot is created. EC (e.g., a fault tolerance technology) is a method of data protection in which each copy of an object is partitioned into stripes, expanded and encoded with redundant data pieces, and stored across different nodes of the datastore. Accordingly, one or more of these techniques implemented in VSAN may offer improved I/O performance for client write requests.

With the proliferation of large database systems, the need for effective recovery solutions has become a critical requirement for the safe management of data. Accordingly, modern storage platforms, including VSAN datastore, enable snapshot features for backup, archival, or data protections purposes. Snapshots provide the ability to capture a point-in-time state and data of a VM to not only allow data to be recovered in the event of failure but restored to known working points. Snapshots may not be stored as physical copies of data blocks (at least initially), but rather may entirely, or in part, be stored as pointers to the data blocks that existed when the snapshot was created. Based on the VSAN architecture, all snapshots of a VM disk may be created natively in a single VSAN object.

To provide consistency for VM backups and to maintain data integrity, I/O quiescing may be performed prior to processing control operations, such as snapshot creation operations. Quiescing is a process of bringing on-disk data of a physical or virtual computer into a state suitable for backups. This process might include such operations as flushing buffers from an operating system's in-memory cache to disk, or other higher-level application-specific tasks. In relation to snapshot creation, the inflight client write I/Os in front of snapshot creation operations may be quiesced prior to creation of the snapshot in order to provide a correct sequence of ordering between I/O and snapshot operations.

Traditional quiescing techniques, however, may be inadequate to meet performance requirements of the datastore. The complexity of managing a very large number of devices and allocating storage for numerous clients sharing these storage devices may result in a large number of I/O operations on the datastore. Using traditional quiescing methods may involve multiple batches of these I/Os to be processed prior to processing the control operation, thereby significantly increasing latency of the datastore. In turn, the write performance of the storage system (initially optimized by implementing WAL, COW, and EC techniques) may suffer. Accordingly, performance-efficient I/O quiescing methods are desired for sequential ordering of operations in such storage systems, including WAL-based storage systems.

It should be noted that the information included in the Background section herein is simply meant to provide a reference for the discussion of certain embodiments in the Detailed Description. None of the information included in this Background should be considered as an admission of prior art.

### BRIEF DESCRIPTION OF THE DRAWINGS

FIG. 1 is a diagram illustrating an example computing environment in which embodiments of the present application may be practiced.

FIG. 2 is a diagram illustrating an embodiment in which a datastore module receives a data block and stores the data in the data block in different memory layers of a hosting system, according to an example embodiment of the present application.

FIG. 3 is a flowchart illustrating a method of input/output (I/O) quiescing for sequential ordering of operations in a write-ahead-log (WAL)-based storage system, according to an example embodiment of the present application.

FIG. 4 is a diagram illustrating an example timeline for I/O quiescing in a WAL-based storage system, according to an example embodiment of the present disclosure.

### DETAILED DESCRIPTION

Aspects of the present disclosure introduce an input/output (I/O) quiescing method for sequential ordering of I/O and control operations in a storage system. As used herein, quiescing may be a process of bringing on-disk data of a physical or virtual computer into a state suitable for backups. The I/O quiescing method described herein may be applied in a write-ahead-log (WAL)-based storage system and provide sequential ordering between control operations and write I/O requests that sequentially precede the control operations by serializing the processing of control operations and an asynchronous buffer flush operation together (e.g., by putting the control operation in the same thread as a buffer flush operation). WAL is a technique commonly used in database systems which persists every change as a command to an append-only log before being written to storage.

A buffer is a region of a physical memory used to temporarily store data while it is being moved from one place to another (e.g., from a cache to persistent storage) and may often be used in conjunction with I/O operations to a storage system. Buffers may increase application performance by allowing file reads or writes to complete quickly and may also improve performance by minimizing the number of times a disk in the storage system is accessed (which may be an expensive operation in terms of performance). In a WAL-based storage system, a client write request may be processed by recording the write request in the WAL and buffering the write request in a memory buffer. When the memory buffer becomes full, payload data of all relevant write requests in the buffer may be asynchronously flushed to a persistent layer of the storage system.

To guarantee sequential order between I/O write requests and control operations, I/O quiescing may be implemented. Snapshot processing is one type of control operation that may use such I/O quiescing. Modern storage platforms may enable snapshot features for backup, archival, or data protections purposes. Snapshots provide the ability to capture a point-in-time state and data to not only allow data to be recovered in the event of failure but restored to known working points. Snapshots do not require an initial copy, as they are not stored as physical copies of data blocks, but rather as pointers to the data blocks that existed when the snapshot was created. Because of this physical relationship, a snapshot may be maintained on the same storage array as the original data.

Without maintaining ordering between snapshots created and I/O write request processing, write requests may be written to incorrect snapshots, thus metadata maintained for these snapshots may be inaccurate. For example, in some embodiments, when flushing a memory buffer with payload data corresponding to one or more client writes, the system may first retrieve a snapshot identifier (ID) of a current running point (RP), which is a pointer to a root node of a B+ tree used to store snapshot metadata. A B+ tree is typically a multi-level data structure having a plurality of nodes, each node containing one or more key-value pairs stored as tuples (e.g., <key, value>), and specifically, a schema of a snapshot logical map B+ tree may include tuples with keys corresponding to <LBA, snapshot identifier (ID)>. The system may use this snapshot ID to create tuples for the client writes in the memory buffer that may be inserted into the snapshot logical map B+ tree. If ordering is not maintained, tuples inserted into the snapshot logical map B+ tree may be inaccurate.

As mentioned, I/O quiescing may be used to ensure correct sequence ordering between the I/O and snapshot operations. A conventional quiescing method may use a range lock mechanism. Range locking applies to the logical address space to prevent concurrency between snapshot creation and processing client write I/Os. The entire range of the logical address space of the RP is locked by an incoming snapshot creation control operation. The snapshot creation control operation is paused until all data update operations (namely client write requests) in front of the control operation have completed and, therefore, cannot release the lock at the range of the data logical space until the data operations are completed. Processing of the control operations commences only after all locks for the range of the logical address space have been released. In other words, either client writes or control operations are being processed at a single time, but not both. In this way, a sequential order between the snapshot creation control operation and relevant data update operations may be guaranteed. Data update operations and control operations may have sequential ordering (e.g., when the data update operations and control operations are part of a same thread). A thread is a small set of instructions designed to be scheduled and executed.

With the range lock mechanism in a WAL-based storage system, dependency of processing the control operation is based upon what is already recorded in the WAL and, thus, may result in undesired latency issues for processing both the control operation and subsequent operations which follow the control operation. These latency issues may have an adverse effect on performance of the storage system in processing these requests. For example, while multiple data update operations preceding the requested control operation may increase delay in processing the control operation, when the multiple data update operations in front of the control operation are also blocked by other data operations, the delay may be exponentially increased, given the control operation may not be processed until all batches of I/O operations are completed. This may not only block processing of the control operation, but also processing of one or more received client write requests after receiving the snapshot creation request. In other words, data update operations behind the snapshot creation control operation may be blocked for an undesired amount of time. For example, in a WAL-based storage system, the system may include inflight write workloads up to a size of the WAL (e.g., 10 megabytes (MB) or greater). Because processing of the control operation is dependent upon what has been recorded in the WAL (e.g., and their locks), in a worst case scenario, the storage system might experience 20 times the expected I/O latency when one batch I/O can only process 512 kilobytes (KB) of payload data (e.g., 10,240 KB (e.g., approximately 10 MB)/512 KB=20).

Accordingly, ordering control between snapshot processing and I/O operations to uphold data integrity while also ensuring efficient performance of the storage system may be desired. The I/O quiescing method presented herein may maintain an order of operations between I/O and control operations while also allowing for increased performance efficiency of the storage system. Specifically, unlike conventional I/O quiescing approaches, control operations may be independent of the WAL and, therefore, processing of control operations may be processed irrespective of whether all data update operations in front of the control operation have been completed. At most, processing of the control operation may wait for one additional I/O to flush the data in the memory buffer (e.g., the in-flight buffer). In this way, the control operation may be processed immediately following completion of the memory buffer flush operation, hence the control operation may not experience any additional quiescing delay. Additionally, control operations may not block incoming client write requests from being processed in the WAL and added to the memory buffer, given control operations are independent of the WAL.

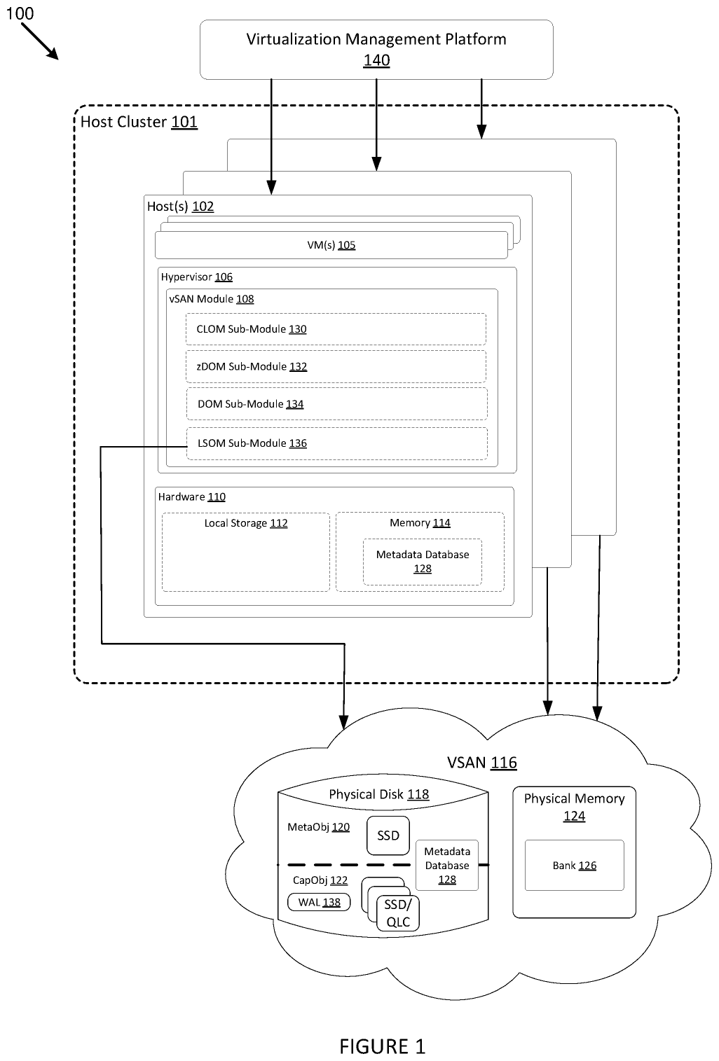

FIG. 1 is a diagram illustrating an example computing environment 100 in which embodiments may be practiced. As shown, computing environment 100 may include a distributed object-based datastore, such as a software-based “virtual storage area network” (VSAN) 116 environment that leverages the commodity local storage housed in or directly attached (hereinafter, use of the term “housed” or “housed in” may be used to encompass both housed in or otherwise directly attached) to host(s) 102 of a host cluster 101 to provide an aggregate object storage to virtual machines (VMs) 105 running on the host(s) 102. The local commodity storage housed in the hosts 102 may include combinations of solid state drives (SSDs) or non-volatile memory express (NVMe) drives, magnetic or spinning disks or slower/cheaper SSDs, or other types of storages. In some embodiments, VSAN 116 may be a write-ahead-log (WAL)-based storage system including a WAL 138, described in more detail below.

Additional details of VSAN are described in U.S. Pat. No. 10,509.708, the entire contents of which are incorporated by reference herein for all purposes, and U.S. patent application Ser. No. 17/181,476, the entire contents of which are incorporated by reference herein for all purposes.

VSAN 116 may manage storage of virtual disks at a block granularity. For example, VSAN 116 may be divided into a number of physical blocks (e.g., 4096 bytes or “4K” size blocks), each physical block having a corresponding physical block address (PBA) that indexes the physical block in storage. Physical blocks of the VSAN 116 may be used to store blocks of data (also referred to as data blocks) used by VMs 105, which may be referenced by logical block addresses (LBAs). Each block of data may have an uncompressed size corresponding to a physical block. Blocks of data may be stored as compressed data or uncompressed data in VSAN 116, such that there may or may not be a one to one correspondence between a physical block in VSAN and a data block referenced by a logical block address. As used herein, an “object” in VSAN 116, for a specified data block, may be created by backing it with physical storage resources of a physical disk 118 (e.g., based on a defined policy).

VSAN 116 may be a two-tier datastore, thereby storing the data blocks in both a smaller, but faster, performance tier and a larger, but slower, capacity tier. The data in the performance tier may be stored in a first object (e.g., a data log that may also be referred to as a MetaObj 120) and when the size of data reaches a threshold, the data may be written to the capacity tier (e.g., in full stripes, wherein a full stripe write refers to a write of data blocks that fill a whole stripe) in a second object (e.g., CapObj 122) in the capacity tier. Accordingly, SSDs may serve as a read cache and/or write buffer in the performance tier in front of slower/cheaper SSDs (or magnetic disks) in the capacity tier to enhance I/O performance. In some embodiments, both performance and capacity tiers may leverage the same type of storage (e.g., SSDs) for storing the data and performing the read/write operations. Additionally, SSDs may include different types of SSDs that may be used in different tiers in some embodiments. For example, the data in the performance tier may be written on a single-level cell (SLC) type of SSD, while the capacity tier may use a quad-level cell (QLC) type of SSD for storing the data.

As further discussed below, each host 102 may include a storage management module (referred to herein as a VSAN module 108) in order to automate storage management workflows (e.g., create objects in MetaObj 120 and CapObj 122 of VSAN 116, etc.) and provide access to objects (e.g., handle I/O operations to objects in MetaObj 120 and CapObj 122 of VSAN 116, etc.) based on predefined storage policies specified for objects in physical disk 118. For example, because a VM 105 may be initially configured by an administrator to have specific storage requirements for its “virtual disk” depending on its intended use (e.g., capacity, availability, I/O operations per second (IOPS), etc.), the administrator may define a storage profile or policy for each VM specifying such availability, capacity, TOPS and the like.

A virtualization management platform 140 is associated with host cluster 101. Virtualization management platform 140 enables an administrator to manage the configuration and spawning of VMs 105 on various hosts 102. As illustrated in FIG. 1, each host 102 includes a virtualization layer or hypervisor 106, a VSAN module 108, and hardware 110 (which includes the storage (e.g., SSDs) of a host 102). Through hypervisor 106, a host 102 is able to launch and run multiple VMs 105. Hypervisor 106, in part, manages hardware 110 to properly allocate computing resources (e.g., processing power, random access memory (RAM), etc.) for each VM 105. Furthermore, as described below, each hypervisor 106, through its corresponding VSAN module 108, provides access to storage resources located in hardware 110 (e.g., storage) for use as storage for virtual disks (or portions thereof) and other related files that may be accessed by any VM 105 residing in any of hosts 102 in host cluster 101.

In one embodiment, VSAN module 108 may be implemented as a “VSAN” device driver within hypervisor 106. In such an embodiment, VSAN module 108 may provide access to a conceptual “VSAN” through which an administrator can create a number of top-level “device” or namespace objects that are backed by the physical disk 118 of VSAN 116. By accessing application programming interfaces (APIs) exposed by VSAN module 108, hypervisor 106 may determine all the top-level file system objects (or other types of top-level device objects) currently residing in VSAN 116.

A file system object may, itself, provide access to a number of virtual disk descriptor files accessible by VMs 105 running in host cluster 101. These virtual disk descriptor files may contain references to virtual disk “objects” that contain the actual data for the virtual disk and are separately backed by physical disk 118. A virtual disk object may itself be a hierarchical, “composite” object that is further composed of “component” objects that reflect the storage requirements (e.g., capacity, availability, IOPs, etc.) of a corresponding storage profile or policy generated by the administrator when initially creating the virtual disk. Each VSAN module 108 (through a cluster level object management or “CLOM” sub-module 130) may communicate with other VSAN modules 108 of other hosts 102 to create and maintain an in-memory metadata database 128 (e.g., maintained separately but in synchronized fashion in memory 114 of each host 102) that may contain metadata describing the locations, configurations, policies and relationships among the various objects stored in VSAN 116. Specifically, in-memory metadata database 128 may serve as a directory service that maintains a physical inventory of the VSAN 116 environment, such as the various hosts 102, the storage resources in hosts 102 (SSD, NVMe drives, magnetic disks, etc.) housed therein and the characteristics/capabilities thereof, the current state of hosts 102 and their corresponding storage resources, network paths among hosts 102, and the like. The in-memory metadata database 128 may further provide a catalog of metadata for objects stored in MetaObj 120 and CapObj 122 of VSAN 116 (e.g., what virtual disk objects exist, what component objects belong to what virtual disk objects, which hosts 102 serve as “coordinators” or “owners” that control access to which objects, quality of service requirements for each object, object configurations, the mapping of objects to physical storage locations, etc.).

In-memory metadata database 128 is used by VSAN module 108 on host 102, for example, when a user (e.g., an administrator) first creates a virtual disk for VM 105 as well as when VM 105 is running and performing I/O operations (e.g., read or write) on the virtual disk.

Various sub-modules of VSAN module 108, including, in some embodiments, CLOM sub-module 130, distributed object manager (DOM) sub-module 134, zDOM sub-module 132, and/or local storage object manager (LSOM) sub-module 136, handle different responsibilities. CLOM sub-module 130 generates virtual disk blueprints during creation of a virtual disk by a user (e.g., an administrator) and ensures that objects created for such virtual disk blueprints are configured to meet storage profile or policy requirements set by the user.

In some cases, the storage policy may define attributes such as a failure tolerance, which defines the number of host and device failures that a VM can tolerate. In some embodiments, a redundant array of inexpensive disks (RAID) configuration may be defined to achieve desired redundancy through mirroring and access performance through erasure coding (EC). EC is a method of data protection in which each copy of a virtual disk object is partitioned into stripes, expanded and encoded with redundant data pieces, and stored across different hosts 102 of VSAN 116. For example, a virtual disk blueprint may describe a RAID 1 configuration with two mirrored copies of the virtual disk (e.g., mirrors) where each are further striped in a RAID 0 configuration. Each stripe may contain a plurality of data blocks. In some cases, including RAID 5 and RAID 6 configurations, each stripe may also include one or more parity blocks. Accordingly, CLOM sub-module 130, in one embodiment, may be responsible for generating a virtual disk blueprint describing a RAID configuration.

CLOM sub-module 130 may communicate the blueprint to its corresponding DOM sub-module 134, for example, through zDOM sub-module 132. DOM sub-module 134 may interact with objects in VSAN 116 to implement the blueprint by, for example, allocating or otherwise mapping component objects of the virtual disk object to physical storage locations within various hosts 102 of host cluster 101. DOM sub-module 134 may also access the in-memory metadata database 128 to determine the hosts 102 that store the component objects of a corresponding virtual disk object and the paths by which those hosts 102 are reachable in order to satisfy the I/O operation.

Each DOM sub-module 134 may need to create their respective objects, allocate local storage 112 to such objects (if needed), and advertise their objects in order to update in-memory metadata database 128 with metadata regarding the object. In order to perform such operations, DOM sub-module 134 may interact with a local storage object manager (LSOM) sub-module 136 that serves as the component in VSAN module 108 that may actually drive communication with the local SSDs (and, in some cases, magnetic disks) of its host 102. In addition to allocating local storage 112 for virtual disk objects (as well as storing other metadata, such as policies and configurations for composite objects for which its node serves as coordinator, etc.), LSOM sub-module 136 may additionally monitor the flow of I/O operations to local storage 112 of its host 102, for example, to report whether a storage resource is congested.

zDOM sub-module 132 may be responsible for caching received data in the performance tier of VSAN 116 (e.g., as a virtual disk object in MetaObj 120) and writing the cached data as full stripes on one or more disks (e.g., as virtual disk objects in CapObj 122). For example, an I/O request to write a block of data may be received by VSAN module 108, and through zDOM sub-module 132 of VSAN module 108, the data may be stored in a physical memory 124 (e.g., a bank 126) and a data log of the VSAN's performance tier first, the data log being stored over a number of physical blocks. Once the size of the stored data in the bank reaches a threshold size, the data stored in the bank may be flushed to the capacity tier (e.g., CapObj 122) of VSAN 116. zDOM sub-module 132 may do full stripe writing to minimize a write amplification effect. Write amplification, refers to the phenomenon that occurs in, for example, SSDs, in which the amount of data written to the memory device is greater than the amount of information you requested to be stored by host 102. Lower write amplification may increase performance and lifespan of an SSD.

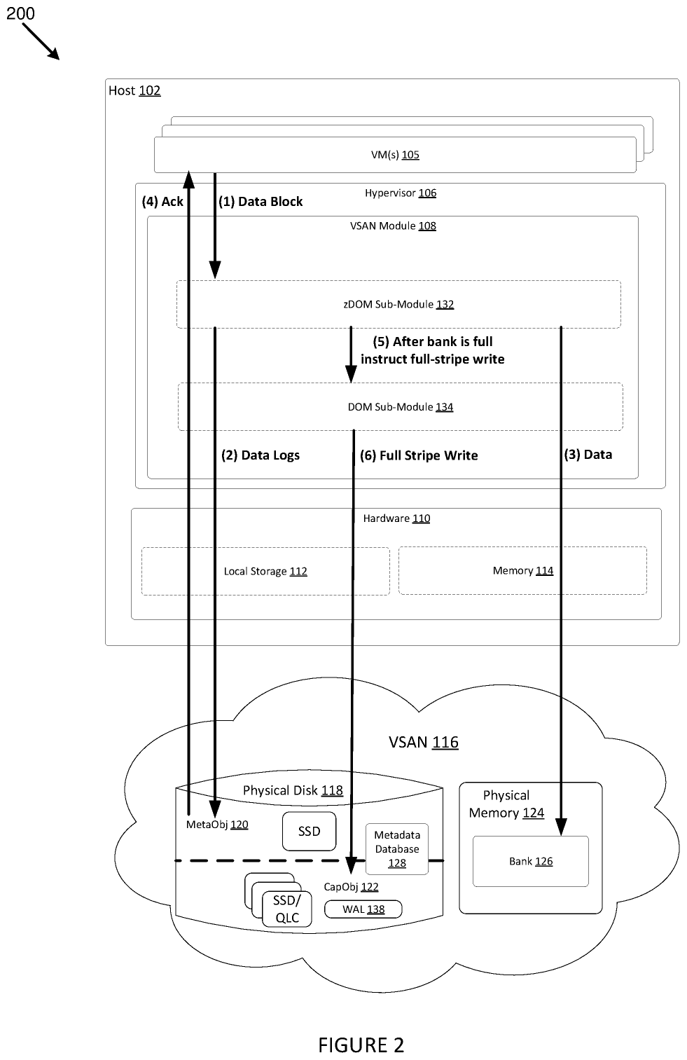

FIG. 2 is a diagram illustrating an embodiment in which VSAN module 108 receives a data block and stores the data in the data block in different memory layers of VSAN 116, according to an example embodiment of the present application.

As shown in FIG. 2, at (1), zDOM sub-module 132 receives a data block from VM 105. At (2), zDOM sub-module 132 instructs DOM sub-module 134 to preliminarily store the data received from the higher layers (e.g., from VM 105) in a data log (e.g., also referred to herein as the MetaObj 120) of the performance tier of VSAN 116 and, at (3), in physical memory 124 (e.g., bank 126).

zDOM sub-module 132 may compress the data in the data block into a set of one or more sectors (e.g., each sector being 512-byte) of one or more physical disks (e.g., in the performance tier) that together store the data log. zDOM sub-module 132 may write the data blocks in a number of physical blocks (or sectors) and write metadata (e.g., the sectors' sizes, snapshot id, block numbers, checksum of blocks, transaction id, etc.) about the data blocks to the data log maintained in MetaObj 120. In some embodiments, the data log in MetaObj 120 includes a set of one or more records, each having a header and a payload for saving, respectively, the metadata and its associated set of data blocks. As shown in FIG. 2, after the data (e.g., the data blocks and their related metadata) is written to MetaObj 120 successfully, then at (4), an acknowledgement is sent to VM 105 letting VM 105 know that the received data block is successfully stored.

In some embodiments, when bank 126 is full (e.g., reaches a threshold capacity that satisfies a full stripe write), then at (5), zDOM sub-module 132 instructs DOM sub-module 134 to flush the data in bank 126 to perform a full stripe write to CapObj 122. At (6), DOM sub-module 134 writes the stored data in bank 126 sequentially on a full stripe (e.g., the whole segment or stripe) to CapObj 122 in physical disk 118.

zDOM sub-module 132 may further instruct DOM sub-module 134 to flush the data stored in bank 126 onto one or more disks (e.g., of one or more hosts 102) when the bank reaches a threshold size (e.g., a stripe size for a full stripe write). The data flushing may occur, while a new bank (not shown in FIG. 2) is allocated to accept new writes from zDOM sub-module 132. The number of banks may be indicative of how many concurrent writes may happen on a single MetaObj 120.

After flushing in-memory bank 126, zDOM sub-module 132 may release (or delete) the associated records of the flushed memory in the data log. This is because when the data stored in the bank is written to CapObj 122, the data is in fact stored on one or more physical disks (in the capacity tier) and there is no more need for storing (or keeping) the same data in the data log of MetaObj 120 (in the performance tier). Consequently, more free space may be created in the data log for receiving new data (e.g., from zDOM sub-module 132).

In order to write full stripe (or full segment), VSAN module 108 may always write the data stored in bank 126 on sequential blocks of a stripe. As such, notwithstanding what the LBAs of a write are, the PBAs (e.g., on the physical disks) may always be continuous for the full stripe write.

In some embodiments, VSAN 116 may implement write ahead logging (e.g., a WAL mechanism). The WAL mechanism may write log records associated with a file write request before it writes the file (e.g., as a data block) to the disk. For example, like other WAL-based storage systems, client requests to write data to VSAN 116 that are received by zDOM sub-module 132 may be processed by recording the received client write request in WAL 138 (e.g., as a log record). WAL 138 may be in persistent storage (e.g., CapObj 122), and memory 114 may also contain an in-memory copy of WAL 138 when payload data is being added to the memory buffer. The logging may be performed prior to any data buffering, client acknowledgement, or flushing of the buffer. A write request may not be considered complete until it has been added to the memory buffer and flushed to the persistent layer; thus, while in WAL 138 the write request may be waiting to be completed.

After logging the client write request in WAL 138, the client write request may be buffered in the memory buffer where it is held until being flushed to the persistent layer (e.g., CapObj 122) of VSAN 116. The memory buffer may also be referred to herein as bank 126 in physical memory 124.

Once the client write request is buffered, the client write request may be acknowledged and the payload data of all write requests in the memory buffer (e.g., bank 126) may be flushed asynchronously to the underlying persistent layer (e.g., CapObj 122) of VSAN 116. As described with respect to FIG. 2, zDOM sub-module 132 may instruct DOM sub-module 134 to flush the data in bank 126 to perform a full stripe write to CapObj 122 when bank 126 is full (e.g., reaches a threshold capacity that satisfies a full stripe write). DOM sub-module 134 writes the stored data in bank 126 sequentially on a full stripe to CapObj 122 in physical disk 118. Logs of client write requests in WAL 138 corresponding to payload data that was flushed to the persistent layer may be truncated or removed. At this point, the data has been committed to storage and servicing of the I/O write request is complete.

In some implementations, timing of the WAL mechanism may depend on timing of one or more control operations regularly requested for the storage system. For example, processing a write request, e.g., by WAL 138 recordation, data buffering, client acknowledgement, and flushing, may depend on process timing for control operations, such as snapshot creation operations.

Aspects of the present disclosure introduce an I/O quiescing method for sequential ordering of I/O and control operations in a storage system, wherein the method serializes the processing of control operations and the asynchronous buffer flush operation together (e.g., by putting the control operation in the same thread as buffer flush operation) to circumvent latency issues created in traditional I/O quiescing methods. According to certain aspects of the present disclosure, to guarantee sequential order between I/O write requests and control operations, the storage system may eagerly force flush the memory buffer, where the memory buffer is not empty, prior to processing any control operation. Additionally, the control operation may be processed regardless of what has been previously recorded in WAL 138 (e.g., control operation is independent of WAL 138). In this way, the control operation may be processed immediately following completion of the memory buffer flush operation, hence the control operation, and I/O operations subsequent to the control operation, may not experience any unnecessary quiescing delay.

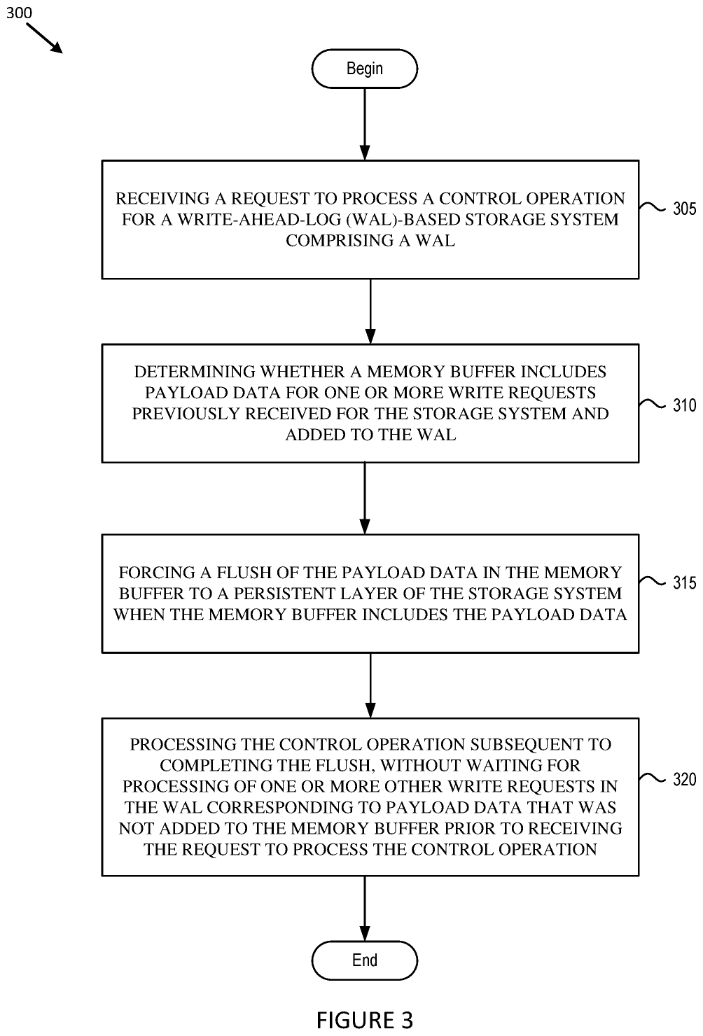

FIG. 3 is a flowchart illustrating a method (or process) 300 of I/O quiescing in a WAL-based storage system, according to an example embodiment of the present application. Process 300 may be performed by a module such as VSAN module 108, through zDOM sub-module 132. In some other embodiments, the method may be performed by other modules that reside in hypervisor 106 or outside of hypervisor 106.

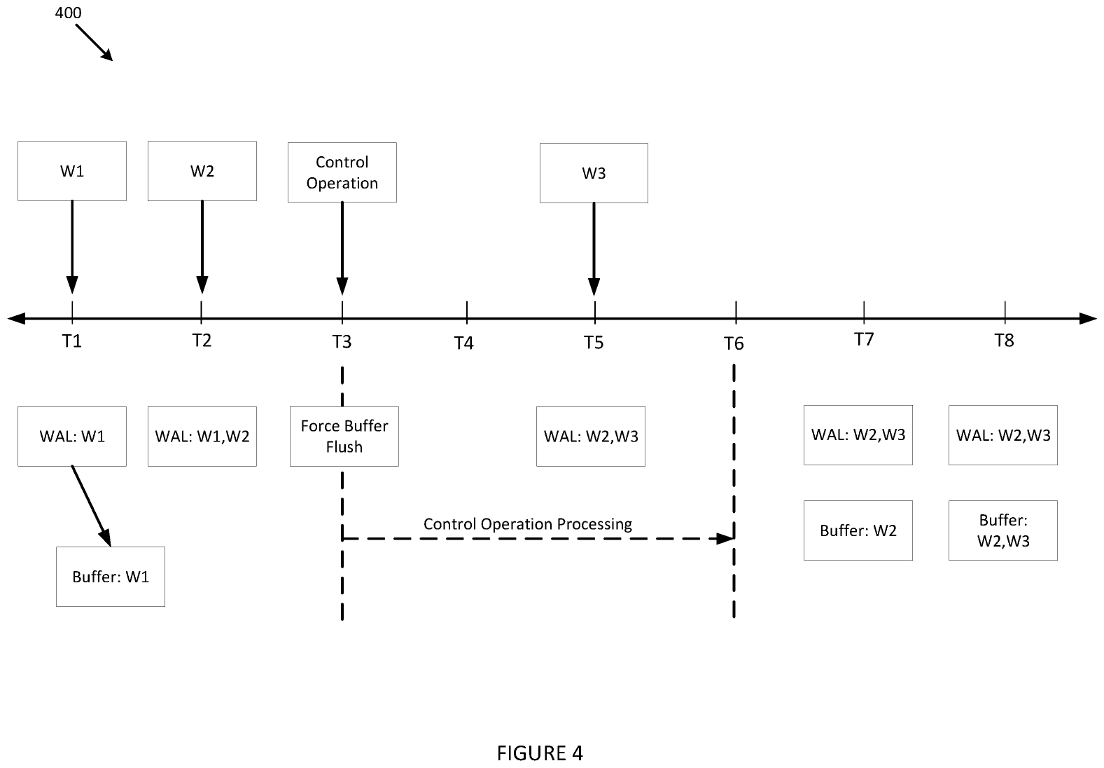

Process 300 may be explained below with reference to FIG. 4. FIG. 4 is a diagram illustrating an example timeline 400 for processing I/Os and control operations, with I/O quiescing in a WAL-based storage system (e.g., VSAN 116 with WAL 138), according to an example embodiment of the present disclosure. In the example illustrated in FIG. 4, the WAL-based storage system may receive a first write request (W1) (as part of a first thread), a second write request (W2) (as part of a second thread), a snapshot creation control operation request (as part of the first thread), and a third write request (W3) (as part of a third thread). As described previously, because W1 and the snapshot creation control operation request are part of a same thread, e.g., the first thread, W1 has sequence ordering with the control operation. While the example illustrated in FIG. 4 depicts only three write requests and a single snapshot creation request, any number of write requests and/or any number or type of control operations (as part of any thread) may be considered when using the quiescing method presented herein.

Process 300 may start, at 305, by zDOM sub-module 132 receiving a request to process a control operation for the storage system. As illustrated in FIG. 4, at time T3 (e.g., where T3>T2>T1), zDOM sub-module 132 receives a request to create a snapshot of the VSAN architecture. However, prior to receipt of the snapshot creation request, zDOM sub-module 132 may have received two write requests. Specifically, at time T1, zDOM sub-module 132 received a first write request, W1, as part of a first thread, to write data corresponding to W1 to VSAN 116. In response to the request, zDOM sub-module 132 recorded W1 in WAL 138 (e.g., as a log record) and buffered W1 in a memory buffer (e.g., bank 126 as illustrated in FIGS. 1 and 2). W1 is held in the memory buffer until it is flushed to the persistent layer of VSAN 116. Additionally, at time T2, zDOM sub-module 132 received a second write request, W2, as part of a second thread, to write data corresponding to W2 to VSAN 116. In response to the request, zDOM sub-module 132 recorded W2 in WAL 138 (e.g., as a log record). Thus, at time T3 (e.g., time of receiving the request to process a snapshot creation request), WAL 138 contained both W1 and W2.

At 310, zDOM sub-module 132 determines whether a memory buffer includes payload data for one or more write requests previously received for the storage system and added to WAL 138. At 315, zDOM sub-module 132 forces a flush of the payload data in the memory buffer to a persistent layer of the storage system when the memory buffer includes the payload data. Force flushing may occur at the time of acknowledging the received control operation (e.g., at the time the control operation is issued to the storage system) and before processing the control operation

With reference to FIG. 4, zDOM sub-module 132 determines, at time T3, the memory buffer includes W1. Because the request to create a snapshot of the VSAN architecture was received prior to buffering W2 in the memory buffer, the memory does not include W2, at this point. Because the memory buffer includes W1 in this example, W1 is flushed from the memory buffer prior to creating the new snapshot.

Although not illustrated, prior to acknowledging the control operation, any write request buffered in memory may be acknowledged to the client. For example, prior to force flushing the memory buffer with W1, client write request, W1, may be acknowledged. The control operation may not be issued to the storage system until write requests buffered in memory have been acknowledged to the client. Further, any write request having sequential ordering (e.g., part of the same thread) with the control operation will be buffered in memory prior to issuing the control operation to the storage system.

Unlike conventional quiescing methods, the control operation may be processed irrespective of other writes recorded in WAL 138, for example W2. For example, when using a conventional range lock mechanism in a WAL-based VSAN, receipt of the control operation may lock the logical address space. Because W1 and W2 are data update operations in front of the snapshot creation control operation that have been recorded in WAL 138, the snapshot creation control operation may be blocked until these write requests are completed. Specifically, only after the buffer with W1 is flushed to the persistent layer of VSAN, W2 is added to the memory buffer, and the buffer with W2 is flushed to the persistent layer of VSAN 116, may all locks in the logical address space be released to allow processing of the snapshot creation control operation to begin. In other words, even though W2 does not have sequential ordering with the snapshot creation control operation, the snapshot creation control operation is unnecessarily blocked until W2 is flushed to the persistent layer of VSAN 116 because W2 is a data update operation in front of the snapshot creation control operation that has been recorded in WAL 138.

At 320, zDOM sub-module 132 processes the control operation subsequent to completing the flush, without waiting for processing of one or more other write requests in WAL 138 corresponding to payload data that was not added to the memory buffer prior to receiving the request to process the control operation. For example, after force flushing the memory buffer containing W1, the snapshot creation control operation may be processed without waiting for W2, in WAL 138, to be buffered in memory. As described previously, creation of a new snapshot may involve the creation of a new RP associated with a new snapshot ID.

In some embodiments, subsequent to receiving the request to process the control operation and prior to processing the control operation, zDOM sub-module 132 may receive a write request from a client to write data to the storage system. Unlike the range lock mechanisms described previously, zDOM sub-module 132 may process the write request. Processing may include recording the write request in WAL 138 and buffering the write request by adding the data for the write request in the buffer memory, or recording the write request in WAL 138, buffering the write request by adding the data for the write request in the buffer memory, and acknowledging the write request to the client. In other words, processing of the snapshot creation control operation may not block any subsequent write requests (e.g., write requests behind the control operation request).

For example, while creating the snapshot (e.g., between time T3 and time T6 in FIG. 4), zDOM sub-module 132 may receive a third write request, W3, to write data corresponding to W3 to VSAN 116. In response to the request, zDOM sub-module 132 records W3 in WAL 138 (e.g., as a log record), such that WAL 138 contains both W2 and W3. In other words, processing of the snapshot creation control operation may not block incoming client write requests, such as W3, from being processed.

This is unlike conventional quiescing methods which, as described previously, block incoming write requests from being recorded in WAL 138 until creation of the snapshot is complete. For example, with respect to conventional range lock mechanisms, W3 may be blocked until processing of the snapshot creation control operation is complete. Clients may consistently ping the system to request the write of W3, and such requests may be denied until processing of the snapshot control operation is complete. In particular, not until after the new snapshot is created may W3 be recorded in WAL 138 and then further processed (e.g., added to the memory buffer, acknowledged, flushed to the persistent layer).

While FIG. 4 illustrates only recording W3 in WAL 138 prior to completion of the snapshot creation, other processing, including buffering the write in memory and/or acknowledging the client requesting the write, may also not be blocked when processing the control operation. Because the control operation doesn't block incoming client write requests from being processed, there is almost no extra performance cost to the storage system, except the minor latency impact introduced by force flushing the memory buffer and executing the control operation.

As further illustrated in FIG. 4, at time T7 and time T8, the system may continue to process client write requests in WAL 138 (and other incoming write requests, although not illustrated in FIG. 4). Specifically, W2 may be buffered in memory at T7, and W3 may be buffered in memory at T8. Although not illustrated, W2 and W3, at a subsequent time, may both be acknowledged to the client, and the buffer with payload data corresponding to W2 and W3 may be flushed to the persistent layer of VSAN 116. Accordingly, unlike the conventional quiescing method described herein, W2 does not unnecessarily block processing of the snapshot creation control operation, and instead W2 may be acknowledged and buffered subsequent to processing the control operation that was issued to the storage system after the write request for W2 was received. Further, W3 is not blocked by the control operation, but can be added to WAL 138.

The I/O quiescing method presented herein may maintain an order of operations between relevant I/O operations and control operations while also allowing for increased performance efficiency of the storage system. Specifically, at most, processing of the control operation may wait for one additional I/O to flush the data in the memory buffer. Additionally, processing control operations may not block incoming client write requests from being processed in WAL 138; thus, the mere impact on write workload throughput may be the duration to process the control operation. For the foregoing reasons, the storage system may have improved performance, at least in terms of latency and efficiency, when servicing both I/O and control operations.

The various embodiments described herein may employ various computer-implemented operations involving data stored in computer systems. For example, these operations may require physical manipulation of physical quantities usually, though not necessarily, these quantities may take the form of electrical or magnetic signals where they, or representations of them, are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer readable media. The term computer readable medium refers to any data storage device that can store data which can thereafter be input to a computer system computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), NVMe storage, Persistent Memory storage, a CD (Compact Discs), CD-ROM, a CD-R, or a CD-RW, a DVD (Digital Versatile Disc), a magnetic tape, and other optical and non-optical data storage devices. The computer readable medium can be a non-transitory computer readable medium. The computer readable medium can also be distributed over a network coupled computer system so that the computer readable code is stored and executed in a distributed fashion. In particular, one or more embodiments may be implemented as a non-transitory computer readable medium comprising instructions that, when executed by one or more processors of a computing system, cause the computing system to perform a method, as described herein.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and datastores are somewhat arbitrary, and particular operations are illustrated in the context of specific illustrative configurations. Other allocations of functionality are envisioned and may fall within the scope of one or more embodiments. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s). In the claims, elements and/or steps do not imply any particular order of operation, unless explicitly stated in the claims.

We claim:

1. A method of input/output (I/O) quiescing in a write-ahead-log (WAL)-based storage system comprising a WAL, the method comprising:
receiving a request to process a control operation for the storage system;
determining whether a memory buffer includes payload data for one or more write requests previously received for the storage system and added to the WAL;
forcing a flush of the payload data in the memory buffer to a persistent layer of the storage system when the memory buffer includes the payload data; and
processing the control operation subsequent to completing the flush, without waiting for processing of one or more other write requests in the WAL corresponding to payload data that was not added to the memory buffer prior to receiving the request to process the control operation.

2. The method of claim 1, wherein when the memory buffer does not include the payload data, the control operation is processed without forcing the flush of the payload data.

3. The method of claim 1, wherein a size of the memory buffer does not reach a threshold before forcing the flush of the payload data in the memory buffer.

4. The method of claim 1, further comprising, subsequent to receiving the request to process the control operation and prior to completion of processing the control operation:
receiving a write request from a client to write data to the storage system; and
processing the write request, wherein processing comprises at least one of:
recording the write request in the WAL;
buffering the write request by adding the data for the write request in the memory buffer; or
acknowledging the write request to the client.

5. The method of claim 4, wherein the data for the write request in the memory buffer is flushed to the persistent layer subsequent to the completion of the processing of the control operation.

6. The method of claim 1, wherein the one or more writes corresponding to the payload data in the memory buffer comprise writes that were previously recorded in the WAL and acknowledged to a client requesting the one or more writes.

7. The method of claim 1, further comprising, prior to receiving the request to process the control operation and prior to completion of processing the control operation:
processing the one or more other write requests in the WAL corresponding to payload data that was not added to the memory buffer, wherein the processing comprises at least one of:
buffering the one or more other write requests by adding data for the one or more other write requests in the memory buffer; or
acknowledging the one or more other write requests to the client.

8. The method of claim 7, wherein the one or more other write requests in the WAL corresponding to payload data that was not added to the memory buffer prior to receiving the request to process the control operation comprises one or more other write requests associated with a different processing thread than the control operation.

9. A system comprising one or more processors and a non-transitory computer readable medium comprising instructions that, when executed by the one or more processors, cause the system to perform a method of input/output (I/O) quiescing in a write-ahead-log (WAL)-based storage system comprising a WAL, the method comprising:
receiving a request to process a control operation for the storage system;
determining whether a memory buffer includes payload data for one or more write requests previously received for the storage system and added to the WAL;
forcing a flush of the payload data in the memory buffer to a persistent layer of the storage system when the memory buffer includes the payload data; and
processing the control operation subsequent to completing the flush, without waiting for processing of one or more other write requests in the WAL corresponding to payload data that was not added to the memory buffer prior to receiving the request to process the control operation.

10. The system of claim 9, wherein when the memory buffer does not include the payload data, the control operation is processed without forcing the flush of the payload data.

11. The system of claim 9, wherein a size of the memory buffer does not reach a threshold before forcing the flush of the payload data in the memory buffer.

12. The system of claim 9, wherein the method further comprises, subsequent to receiving the request to process the control operation and prior to completion of processing the control operation:
receiving a write request from a client to write data to the storage system; and
processing the write request, wherein processing comprises at least one of:
recording the write request in the WAL;
buffering the write request by adding the data for the write request in the memory buffer; or
acknowledging the write request to the client.

13. The system of claim 12, wherein the data for the write request in the memory buffer is flushed to the persistent layer subsequent to the processing of the control operation.

14. The system of claim 9, wherein the one or more writes corresponding to the payload data in the memory buffer comprise writes that were previously recorded in the WAL and acknowledged to a client requesting the one or more writes.

15. A non-transitory computer readable medium comprising instructions that, when executed by one or more processors of a computing system, cause the computing system to perform a method of input/output (I/O) quiescing in a write-ahead-log (WAL)-based storage system comprising a WAL, the method comprising:
receiving a request to process a control operation for the storage system;
determining whether a memory buffer includes payload data for one or more write requests previously received for the storage system and added to the WAL;
forcing a flush of the payload data in the memory buffer to a persistent layer of the storage system when the memory buffer includes the payload data; and
processing the control operation subsequent to completing the flush, without waiting for processing of one or more other write requests in the WAL corresponding to payload data that was not added to the memory buffer prior to receiving the request to process the control operation.

16. The non-transitory computer readable medium of claim 15, wherein when the memory buffer does not include the payload data, the control operation is processed without forcing the flush of the payload data.

17. The non-transitory computer readable medium of claim 15, wherein a size of the memory buffer does not reach a threshold before forcing the flush of the payload data in the memory buffer.

18. The non-transitory computer readable medium of claim 15, wherein the method further comprises, subsequent to receiving the request to process the control operation and prior to completion of processing the control operation:
receiving a write request from a client to write data to the storage system; and
processing the write request, wherein processing comprises at least one of:
recording the write request in the WAL;
buffering the write request by adding the data for the write request in the memory buffer; or
acknowledging the write request to the client.

19. The non-transitory computer readable medium of claim 18, wherein the data for the write request in the memory buffer is flushed to the persistent layer subsequent to the processing of the control operation.

20. The non-transitory computer readable medium of claim 15, wherein the one or more writes corresponding to the payload data in the memory buffer comprise writes that were previously recorded in the WAL and acknowledged to a client requesting the one or more writes.
